(19) United States
(12) Patent Application Publication
(10) Pub. No.: US 2025/0068812 A1
(43) Pub. Date: Feb. 27, 2025

(54) IMPROVING COVERAGE IN FUNCTIONAL VERIFICATION BY COORDINATED RANDOMIZATION OF VARIABLES ACROSS MULTIPLE CLASSES

(71) Applicant: Synopsys, Inc., Sunnyvale, CA (US)

(72) Inventors: Parijat Biswas, Bangalore (IN); Danish Jawed, Surrey (CA); Siddarth Sharma, Delhi (IN); Badri Prasad Gopalan, Cupertino, CA (US)

(21) Appl. No.: 18/456,042

(22) Filed: Aug. 25, 2023

(51) Int. Cl. G06F 30/33

(52) U.S. Cl. CPC G06F 30/33

(57) ABSTRACT

A description of stimuli used for functional verification of a circuit design is received. The description includes classes of variables and the variable include random variables. A coverage model for the functional verification of the circuit design is also received. The coverage model includes coverage targets that are functions of the variables. A processing device generates stimuli for multiple iterations of the functional verification, as follows. Context values, which include values of the random variables for the stimuli, are maintained. The values of the random variables in an individual class are randomized, and the randomization of the random variables in the individual class is biased to hit the coverage targets given the context values for the random variables outside the individual class. Whether the coverage targets are hit by the generated stimuli is determined.

### TECHNICAL FIELD

The present disclosure relates to functional verification of circuit designs and, more particularly, to improving the generation of enough stimuli to adequately verify the design.

### BACKGROUND

Functional verification is a process for determining whether a circuit design functions as intended. Coverage refers to the extent to which different stimuli applied to the circuit design exercise (or cover) the intended or specified functionality. Coverage closure is the process of developing a set of stimuli that covers enough test cases to adequately test the circuit design.

However, one challenge of coverage closure is the ability to generate stimuli that exercise rarely occurring functionality of the circuit. In a constraint-random verification setting, some stimuli are modeled as random variables. The values of these stimuli are randomly selected, leading to a certain distribution of which test cases are exercised. Commonly occurring test cases are hit (exercised) frequently by randomly generated stimuli, and moderately common test cases are hit with moderate frequency. However, some test cases may be hit only rarely. The infrequency of these hits consumes a disproportionate number of processing cycles to reach coverage closure.

### SUMMARY

In some aspects, a method includes the following. A description of stimuli used for functional verification of a circuit design is received. The description includes classes of variables and the variable include random variables. A coverage model for the functional verification of the circuit design is also received. The coverage model includes coverage targets that are functions of the variables. A processing device generates stimuli for multiple iterations of the functional verification, as follows. Context values, which include values of the random variables for the stimuli, are maintained. The values of the random variables in an individual class are randomized, and the randomization of the random variables in the individual class is biased to hit the coverage targets given the context values for the random variables outside the individual class. Whether the coverage targets are hit by the generated stimuli is determined.

In another aspect, a system includes a compiler and a verification testbench. The compiler receives a coverage model for functional verification of a circuit design. The coverage model includes coverage targets that are functions of variables for stimuli used for the functional verification. The variables include random variables. From the coverage model, the compiler determines and stores context connectivity information that identifies which coverage targets depend on which random variables. The verification testbench performs multiple stages of constrained random verification of the circuit design. Each stage is for a selected set of coverage targets and a selected class of variables. For each stage, the context connectivity information is accessed to identify which random variables the selected set of coverage targets depends on. Context values from prior stages for values of random variables outside the selected class are accessed. The values of random variables in the selected class are randomized for multiple iterations, but the randomization is biased to hit the coverage targets given the context values for the random variables outside the selected class. The context values are updated.

Other aspects include components, devices, systems, improvements, methods, processes, applications, computer readable mediums, and other technologies related to any of the above.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a flow diagram for generating test stimuli, in accordance with some embodiments of the present disclosure.

FIG. 2 shows parts of a verification testbench and coverage model, in accordance with some embodiments of the present disclosure.

FIGS. 3A and 3B are another flow diagram for generating test stimuli, in accordance with some embodiments of the present disclosure.

FIGS. 4A and 4B show experimental results for generating test stimuli, in accordance with some embodiments of the present disclosure.

FIG. 5 depicts a flowchart of various processes used during the design and manufacture of an integrated circuit, in accordance with some embodiments of the present disclosure.

FIG. 6 depicts a diagram of an example computer system in which embodiments of the present disclosure may operate.

### DETAILED DESCRIPTION

Aspects of the present disclosure relate to improving coverage in functional verification by coordinated randomization of variables across multiple classes. In one approach to verification, stimuli are applied to a circuit design. The operation of the circuit is simulated or otherwise analyzed, and the resulting behavior is compared to the desired behavior to determine whether the circuit will operate properly. Different stimuli exercise different test cases that may be referred to as coverage targets. If a stimulus exercises a test case, it is said to hit or cover that coverage target. Coverage closure is the process of developing sufficient stimuli to hit all desired coverage targets.

In constraint-random verification, some of the stimuli are represented as random variables. The values of these variables are randomly selected to generate different stimuli. The variables may be grouped into classes, with the random variables randomized one class at a time. In other words, the random variables of various classes are randomized individually during the course of simulation.

However, generating a set of stimuli that covers all coverage targets may take a long time using this approach. Some coverage targets may depend on random variables from different classes, but these random variables from different classes are not randomized together. Only the variables in the current class are randomized, without considering the current values of the variables that are outside the current class. This may result in many combinations of random variables that do not increase the coverage, particularly when trying to hit coverage targets that occur only rarely given the default distributions for the randomization.

In one aspect, coverage closure may be accelerated by biasing the randomization. Rather than using the default distribution and constraints, the randomization may be biased to increase the chance of hitting coverage targets by considering the current coverage (e.g., which coverage targets are not yet hit) and the values of other variables that also affect these coverage targets. The randomization may be biased towards increasing the chance of hitting certain coverage targets, given the values of these other variables.

The conditions within which the randomization occurs may be referred to as the context. The values of other variables may be referred to as context values, and the other variables may be referred to as context variables. Which variables are context variables depends on the class that is being randomized and the coverage targets that are being considered.

In one implementation, variables of different classes are randomized one class at a time in different stages of the constraint-random verification, and data structures are used to store and pass the context between these stages. Before run-time, a compiler (e.g. implemented using a processing device performing instructions) may analyze a coverage model to determine which coverage targets depend on which random variables, and this context connectivity information may be stored in a database. At run-time, the values of the random variables and the coverage (e.g., holes in the coverage) may be tracked as the constraint-random verification progress. At each stage, which random variables are relevant to the current coverage targets may be determined from the context connectivity information, and the current values for the random variables outside the currently randomized class may be determined from the tracked context values. The randomization of the selected class may then be biased to hit holes in the coverage targets, given the context values for the variables outside the class.

Technical advantages of the present disclosure include, but are not limited to, the following. Automated coverage closure enables teams to accelerate and improve the quality of verification, and the overall design process. Biasing the randomization increases the chance of generating stimuli that will hit coverage holes. This reduces the number of stimuli generated to reach coverage closure or other coverage goals. This reduces the overall time required to generate sufficient stimuli to reach coverage closure. It also reduces the overall time required for functional verification using the stimuli. With fewer stimuli, the associated processor, memory and data bandwidth requirements are also reduced. Fewer processor cycles are required to simulate the test cases using fewer stimuli, less memory is required to store the fewer stimuli and the results of their simulations, and less data bandwidth is required to move all of this data around.

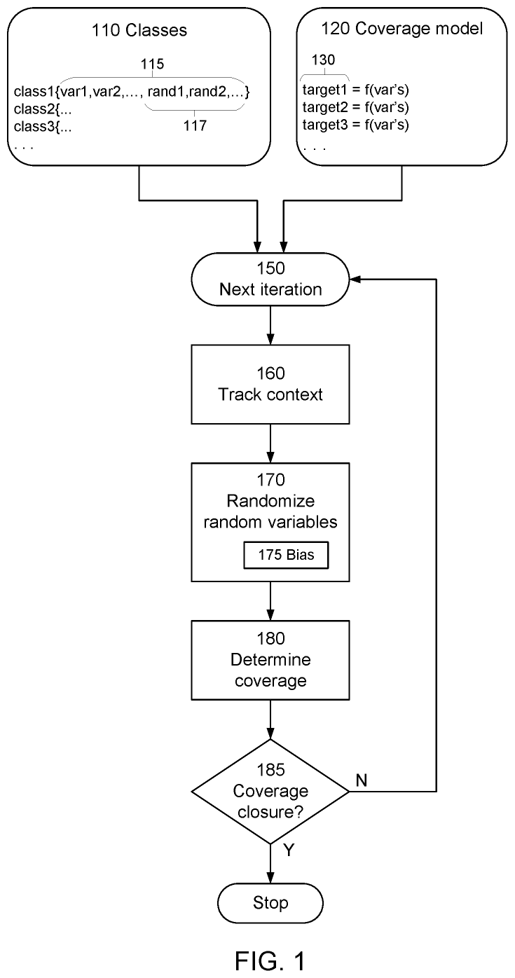

FIG. 1 is a flow diagram for generating test stimuli, in accordance with some embodiments of the present disclosure. The flow generates stimuli that will be used in functional verification of a circuit design. The flow receives a description of the inputs (stimuli) for the functional verification, which are defined by variables. The variables 115 are grouped into classes 110. In FIG. 1, class1 includes variables {var1, var2, . . . , rand1, rand2, . . . } where rand* are random variables 117, and so on for class2, class3, etc.

The classes are descriptions of different objects or constructs used in the circuit design. For example, there may be a class defined for packets. It might have a command field, an address, a sequence number, a time stamp, and a packet payload. In addition, there are various actions that can be done with a packet: initialize the packet, set the command, read the packet's status, or check the sequence number. Each packet is different, but as a class, packets have certain intrinsic properties that can be captured in the class definition. The class definition includes the variables used in the description of the class. In other words, a class is a user-defined data type that encapsulates data and functions related to that data.

The verification process has coverage targets to be reached, which are defined in a coverage model 120. The coverage model 120 defines the coverage targets 130 as a function of the variables 115. Some of the variables 115 may be random variables 117. The values of random variables are randomly selected according to some probability distribution, subject to constraints on the values.

For the verification process, values of the random variables are randomly selected according to the probability distribution for that variable and subject to the constraints on that variable. FIG. 1 shows multiple iterations 150 to generate stimuli for the verification. The flow in FIG. 1 biases the randomization to improve verification coverage. At 160, the context of the verification is tracked. This includes maintaining the current values of random variables. At 170, the values of some random variables are randomized. Different random variables or class(es) of random variables may be randomized during different iterations. The remaining random variables which are not randomized for the current iteration are context variables for that iteration. The randomization at 170 is biased at 175 to hit coverage targets, given the values of the context variables. For example, if there are holes in the coverage produced by the previous stimuli, then the randomization may be biased at 175 towards hitting those holes, thus increasing the overall coverage.

At 180, the current coverage is determined. This includes determining which coverage targets are hit by the newly generated stimuli. At 185, if coverage closure is not yet achieved (e.g., based on a threshold closure target), then more iterations are run, and more stimuli are generated. FIG. 1 shows a single loop of iterations 150, but the process may be implemented using multiple loops. For example, steps 180 and 185 may not be checked after every new stimulus is generated. Rather, a group of stimuli may be generated and then steps 180 and 185 are performed once for the entire group.

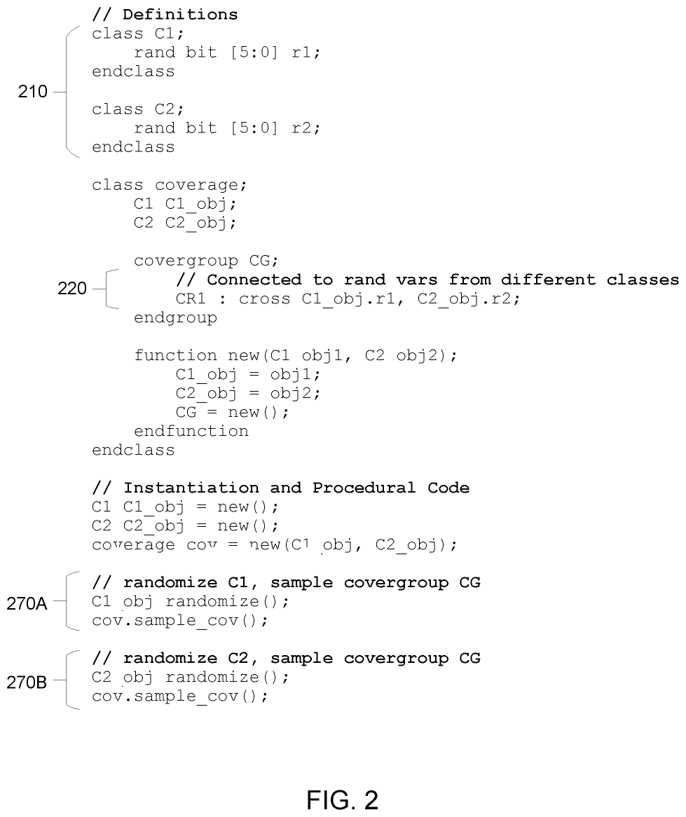

FIG. 2 shows parts of a verification testbench and coverage model, in accordance with some embodiments of the present disclosure. In this SystemVerilog testbench example, the random variables r1 and r2 are data members of classes C1 and C2 respectively, as defined by lines 210. These random variables are connected to the coverage target CR1 of covergroup CG, by lines 220. In this specific example, the coverage target CR1 is the cross-product of the random variables r1 and r2.

In the procedural code 270A,B of this example, the class objects C1_obj (of class C1) and C2_obj (of class C2) are randomized and the covergroup CG is sampled post each randomization. However, the two classes are randomized separately, at different stages in the verification. Lines 270A implement the randomization of random variable r1, and lines 270B implement the randomization of random variable r2. Without some sharing of context, each randomization will proceed without knowing that the random variables r1 and r2 are both connected to the coverage target CR1, resulting in slower coverage closure. With sharing of context, the randomizations may be biased to accelerate coverage closure. The bias based on shared context may be implemented in the code of the randomize( ) methods.

Different types of bias may be implemented. Consider a simple example where random variables v1 and v2 are integer numbers constrained to fall within the range [0:10]. Let a coverage target CT be the sum of v1 and v2, so target CT has possible range of [0:20]. Previously generated stimuli covered values of CT from [0:15], so there is currently a coverage hole of (15:20] for CT. Assume that the two variables v1 and v2 are in different classes, so that only one of the two will be randomized during any stage. Let v1 be the randomized variable and let v2=8 for the current stage.

If there is no context sharing, then v1 will be randomized over the range [0:10]. However, lower values of v1 will not fill any of the coverage hole and will unnecessarily increase the time required for coverage closure. With context sharing and knowledge of the coverage holes in CT, v1 may be constrained to the range (7,10] so that any random values will hit some hole in the coverage. In this example, the bias was implemented by temporarily modifying the constraint on v1, changing its value range from [0:10] to (7,10]. The modification is temporary because different conditions in other stages may result in different constraints.

In an alternative approach, rather than modifying the constraint, the probability distribution for the randomization may be temporarily modified. The randomization for v1 uses a uniform distribution over [0:10]. This may be modified to skew towards the high end of the range, thus increasing the chance of hitting uncovered targets. In some cases, there may be multiple coverage targets that may interact in different ways. They may have overlapping requirements on the randomized variables, or they may have conflicting requirements. Modifying the probability distribution is one way to address multiple, possibly conflicting, requirements.

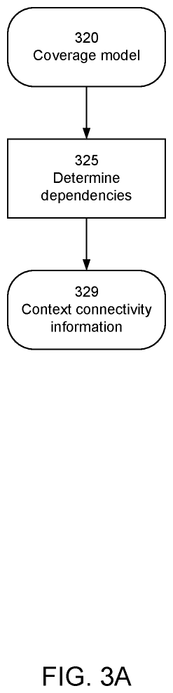

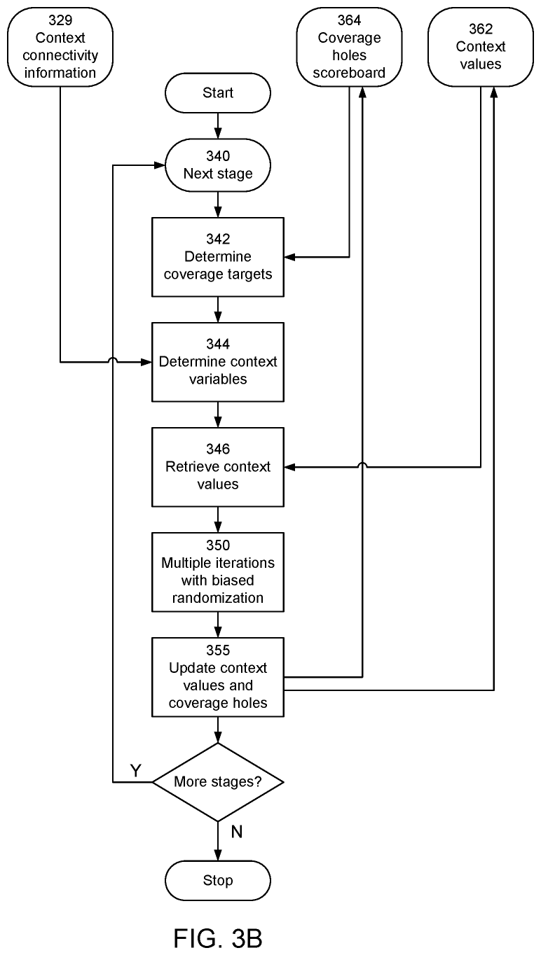

FIGS. 3A and 3B are another flow diagram for generating test stimuli, in accordance with some embodiments of the present disclosure. This flow includes two parts: a compilation that occurs prior to run-time of the verification testbench shown in FIG. 3A, and then the run-time of the verification shown in FIG. 3B.

In FIG. 3A, the compiler receives the coverage model 320, for example as defined by classes “C1” “C2” and “coverage” in FIG. 2. At 325, the compiler analyzes the coverage model to determine which coverage targets depend on which random variables. In the example of FIG. 2, the coverage target “CR1” depends on the random variables “r1” and “r2.” This information connects different coverage targets to different contexts. It will be referred to as context connectivity information 329. The dependencies of the coverage targets on the random variables may be one-to-many, one-to-one, and/or many-to-one. The context connectivity information 329 may be stored in a database for use at run-time.

The verification run-time is shown in FIG. 3B. In addition to the context connectivity information 329, the run-time also accesses values of random variables from prior stages (context values 362) and extent of the current coverage 364. In this example, the current coverage 364 is represented by a coverage holes scoreboard that tracks holes in the current coverage. The scoreboard may be stored as a database.

The verification is run in stages 340. Each stage performs constrained random verification for a particular set of coverage targets and randomizing a specific class of random variables. The coverage targets and randomized class may change from stage to stage.

Each stage 340 proceeds as follows. At 342, the coverages holes scoreboard 364 is accessed to determine coverage targets for the current stage. At 344, the context connectivity information 329 is accessed to determine which random variables make up the context for the selected set of coverage targets. In the example of FIG. 2, if the current stage includes coverage target “CR1,” then the context connectivity information indicates that “CR1” depends on random variables “r1” and “r2.” The coverage target cg1.CR1 has the context {C1::r1, C2::r2}. Assume that class “C1” is the randomized class for the current stage, then “r1” is a randomized variable and “r2” is a context variable for this stage. At 346, the values for the context variables are retrieved from the context values database 362.

At 350, multiple iterations of the verification are performed, using randomized values for variables in the randomized class. Continuing the above example, the value of “r1” is randomized. However, the randomization is biased to hit the selected coverage targets (e.g., holes in the coverage of “CR1”), given the context values for the context variables (e.g., the value of “r2” retrieved from the context values database 362).

At 355, the values of “r1” in the context values database are updated. Although not being randomized, the values of “r2” may also change and those values are also updated. Context values may change as a result of randomization of the class. They may also change as a result of assignments to variables in the course of the verification. At 355, the coverage holes scoreboard 364 is also updated.

At 340, the process is then repeated for the next stage. Assume that class “C2” is the randomized class for the next stage. Then “r2” will be a randomized variable and “r1” will be a context variable. The flow may perform stages sequentially, stepping through the classes one class at a time. Alternatively, different stages may be performed in parallel, with each stage updating the various databases 362, 364 as the stage progresses.

Individual stages may be performed by a SystemVerilog constraint solver. The constraint solver treats the randomized variables as random and context variables as state variables that are not randomized. It solves for values of the random variables that hit the specified coverage target.

Consider the following example.

```
class TFoo;
  rand bit [3:0] a;
  constraint cb {
      a inside {[0:10]};
  }
endclass
```

The random variable “a” is 4-bit wide variable with value range [0:15]. The inside constraint on “a” dictates that the valid value range for this variable is [0:10]. The constraint solver gathers this information and then solves for an appropriate value for “a”. Since the constraint solver is agnostic to the fact that the random variables of a class are connected to a coverage target, the generated solver solutions might not suffice in terms of efficient closure of coverage target.

The context values database 362 may be organized in different ways. In one approach, it is organized by class. For each class, the database maintains the context values for random variables outside the class. It may also be organized by coverage target. For each coverage target, the database maintains the context values for random variables on which the coverage target depends.

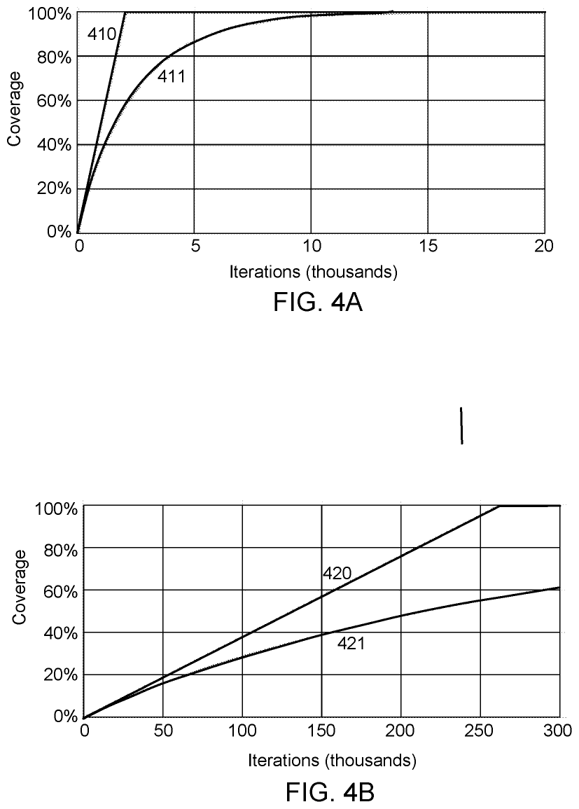

FIGS. 4A and 4B show experimental results for generating test stimuli, in accordance with some embodiments of the present disclosure. Both figures plot the percentage of coverage as a function of the number of iterations (number of stimuli generated).

The example of FIG. 4A has two SystemVerilog classes which contain random variables and are connected to one covergroup. Each random variable is 6 bits in size and can take 64 possible values. A cross product can take 64×64=4096 values. However, each random variable is independently randomized as they are in separate classes. Curve 410 shows coverage closure using the approach described herein. Each value of the cross product is hit within 4098 cumulative randomizations of the classes. Without this technique, on average it can take more than 20,000 cumulative randomizations as shown by curve 411. Not having the context available and not considering it during randomization results in redundancy in the value generation during the randomization process.

FIG. 4B shows an example using three classes that are all connected to one covergroup. The covergroup has approximately 256,000 bins. A bin is a value or range of values for a coverage target. Curve 420 is for the approach described herein. It achieves coverage closure in approximately 265,000 iterations. In contrast, the approach of curve 421 without context sharing has achieved only 61% coverage at 300,000 iterations and will require more than 1,500,000 iterations to achieve complete closure.

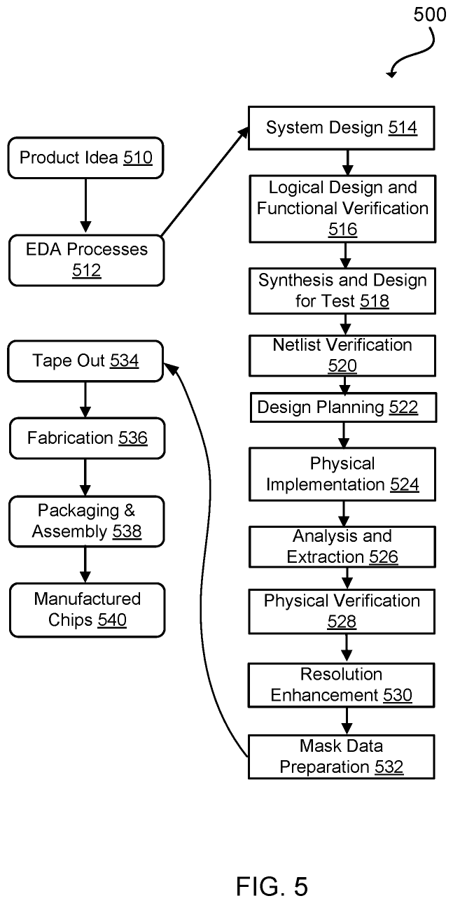

FIG. 5 illustrates an example set of processes 500 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 510 with information supplied by a designer, information which is transformed to create an article of manufacture that uses a set of EDA processes 512. When the design is finalized, the design is taped-out 534, which is when artwork (e.g., geometric patterns) for the integrated circuit is sent to a fabrication facility to manufacture the mask set, which is then used to manufacture the integrated circuit. After tape-out, a semiconductor die is fabricated 536 and packaging and assembly processes 538 are performed to produce the finished integrated circuit 540.

Specifications for a circuit or electronic structure may range from low-level transistor material layouts to high-level description languages. A high-level of representation may be used to design circuits and systems, using a hardware description language (‘HDL’) such as VHDL, Verilog, SystemVerilog, SystemC, MyHDL or OpenVera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 5. The processes described by be enabled by EDA products (or EDA systems).

During system design 514, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 516, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 518, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 520, the netlist is checked for compliance with timing constraints and for correspondence with the HDL code. During design planning 522, an overall floor plan for the integrated circuit is constructed and analyzed for timing and top-level routing.

During layout or physical implementation 524, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 526, the circuit function is verified at the layout level, which permits refinement of the layout design. During physical verification 528, the layout design is checked to ensure that manufacturing constraints are correct, such as DRC constraints, electrical constraints, lithographic constraints, and that circuitry function matches the HDL design specification. During resolution enhancement 530, the geometry of the layout is transformed to improve how the circuit design is manufactured.

During tape-out, data is created to be used (after lithographic enhancements are applied if appropriate) for production of lithography masks. During mask data preparation 532, the ‘tape-out’ data is used to produce lithography masks that are used to produce finished integrated circuits.

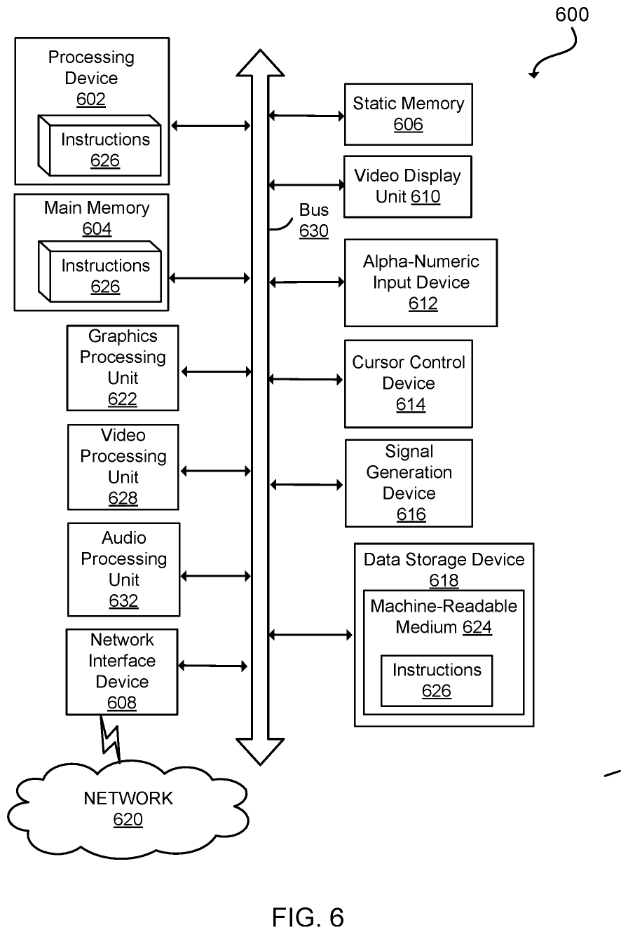

A storage subsystem of a computer system (such as computer system 600 of FIG. 6) may be used to store the programs and data structures that are used by some or all of the EDA products described herein, and products used for development of cells for the library and for physical and logical design that use the library.

FIG. 6 illustrates an example machine of a computer system 600 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM), a static memory 606 (e.g., flash memory, static random access memory (SRAM), etc.), and a data storage device 618, which communicate with each other via a bus 630.

Processing device 602 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 may be configured to execute instructions 626 for performing the operations and steps described herein.

The computer system 600 may further include a network interface device 608 to communicate over the network 620. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), a graphics processing unit 622, a signal generation device 616 (e.g., a speaker), graphics processing unit 622, video processing unit 628, and audio processing unit 632.

The data storage device 618 may include a machine-readable storage medium 624 (also known as a non-transitory computer-readable medium) on which is stored one or more sets of instructions 626 or software embodying any one or more of the methodologies or functions described herein. The instructions 626 may also reside, completely or at least partially, within the main memory 604 and/or within the processing device 602 during execution thereof by the computer system 600, the main memory 604 and the processing device 602 also constituting machine-readable storage media.

In some implementations, the instructions 626 include instructions to implement functionality corresponding to the present disclosure. While the machine-readable storage medium 624 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 602 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method comprising:
receiving a description of stimuli used for functional verification of a circuit design, the description comprising classes of variables that include random variables; and
receiving a coverage model for the functional verification of the circuit design; the coverage model comprising coverage targets that are functions of the variables;
generating, by a processing device, the stimuli for multiple iterations of the functional verification, comprising:
maintaining context values comprising values of the random variables for the stimuli;
randomizing values of the random variables in an individual class; and
biasing the randomization of the random variables in the individual class to hit the coverage targets given the context values for the random variables outside the individual class; and
determining whether the coverage targets are hit by the generated stimuli.

2. The method of claim 1, further comprising:
maintaining coverage holes data indicating which coverage targets have not yet been hit by previously generated stimuli, wherein randomization of the random variables is biased to hit the unhit coverage targets based on the coverage holes data.

3. The method of claim 1, wherein biasing the randomization of the random variables comprises applying temporary constraints to the randomization of the random variables.

4. The method of claim 1, wherein biasing the randomization of the random variables comprises temporarily modifying a probability distribution for the randomization.

5. The method of claim 1, wherein generating stimuli for multiple iterations of the functional verification further comprises randomizing values of the random variables one class at a time.

6. The method of claim 1, further comprising:
based on the coverage model, identifying which coverage targets depend on which random variables.

7. The method of claim 1, wherein the classes are user-defined data types that encapsulate data and functions related to that data.

8. A system comprising a compiler and a verification testbench, wherein:
the compiler is configured to:
receive a coverage model for functional verification of a circuit design; the coverage model comprising coverage targets that are functions of variables for stimuli used for the functional verification, the variables including random variables; and
from the coverage model, determine and store context connectivity information that identifies which coverage targets depend on which random variables; and
the verification testbench is configured to perform multiple stages of constrained random verification of the circuit design, each stage for a selected set of coverage targets and for a selected class of variables; each stage comprising:
accessing the context connectivity information to identify which random variables the selected set of coverage targets depends on;
accessing context values from prior stages for values of random variables outside the selected class;
performing multiple iterations of randomizing values of random variables in the selected class, wherein the randomization is biased to hit the coverage targets given the context values for the random variables outside the selected class; and
updating the context values.

9. The system of claim 8, wherein performing the multiple stages randomizes values of the random variables one class at a time.

10. The system of claim 9, wherein the multiple stages are performed in parallel.

11. The system of claim 8, wherein the context connectivity information includes one-to-many, one-to-one, and many-to-one dependencies of the coverage targets on the random variables.

12. The system of claim 8, wherein the verification testbench comprises a SystemVerilog constraint solver.

13. The system of claim 12, wherein the random variables outside the selected class are treated as state variables by the SystemVerilog constraint solver.

14. The system of claim 8, wherein the verification testbench includes a database containing the context connectivity information and the context values from prior stages.

15. The system of claim 8, wherein the verification testbench includes a database containing, for each class, the context values for random variables outside the class.

16. The system of claim 8, wherein the verification testbench includes a database containing, for each coverage target, the context values for random variables on which the coverage target depends.

17. A non-transitory computer readable medium comprising stored instructions, which when executed by a processing device, cause the processing device to perform multiple stages of:
determining which random variables on which a set of coverage targets depend;
wherein the random variables are stimuli for functional verification of a circuit design, and the coverage targets are coverage targets for the functional verification;
determining a class of the random variables for randomization during the current stage;
retrieving values of random variables that are outside the class;
performing multiple iterations of:
randomizing values of the random variables in the class, wherein the randomization is biased to hit the coverage targets given the values of the random variables outside the class; and
performing the functional verification using the randomized values for the random variables in the class and using the retrieved values for random variables outside the class.

18. The non-transitory computer readable medium of claim 17, wherein the coverage targets include cross-products of random variables in the class with random variables outside the class.

19. The non-transitory computer readable medium of claim 17, wherein the random variables are user-defined and subject to user-defined constraints on values of the random variables.

20. The non-transitory computer readable medium of claim 17, wherein the class is a user-defined data type that encapsulates data and functions related to that data.
